(19) United States
(12) Patent Application Publication
(10) Pub. No.: US 2025/0202670 A1
(43) Pub. Date: Jun. 19, 2025

(54) CONFIGURING TRANSMISSION CONFIGURATION INDICATOR TYPES FOR TRANSMISSION RECEPTION POINTS IN MULTIPLE TRANSMISSION RECEPTION POINT OPERATIONS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/847,803

(22) PCT Filed: May 12, 2022
(86) PCT No.: PCT/CN2022/092366

§ 371 Date: Sep. 17, 2024

(51) Int. Cl. H04L 5/00; H04W 72/232

(52) U.S. Cl. CPC H04L 5/0092; H04L 5/0035; H04W 72/232

(57) ABSTRACT

Various aspects of the present disclosure generally relate to wireless communication. In some aspects, a user equipment (UE) may receive a multiple transmission-reception point (mTRP) configuration that indicates a first transmission configuration indicator (TCI) state type corresponding to a first transmission-reception point (TRP) and a second TCI state type corresponding to a second TRP. The UE may communicate based at least in part on the mTRP configuration. Numerous other aspects are described.

### FIELD OF THE DISCLOSURE

Aspects of the present disclosure generally relate to wireless communication and to techniques and apparatuses for configuring transmission configuration indicator types for transmission reception points in multiple transmission reception point operations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include memory, one or more processors coupled to the memory, and instructions stored in the memory and executable by the one or more processors. The instructions may be executable by the one or more processors to cause the user equipment to receive a multiple transmission-reception point (mTRP) configuration that indicates a first transmission configuration indicator (TCI) state type corresponding to a first transmission-reception point (TRP) and a second TCI state type corresponding to a second TRP. The instructions may be executable by the one or more processors to cause the user equipment to communicate based at least in part on the mTRP configuration.

Some aspects described herein relate to a network node for wireless communication. The network node may include memory, one or more processors coupled to the memory, and instructions stored in the memory and executable by the one or more processors. The instructions may be executable by the one or more processors to cause the network node to transmit an mTRP configuration that indicates a first TCI state type corresponding to a first TRP and a second TCI state type corresponding to a second TRP. The instructions may be executable by the one or more processors to cause the network node to communicate based at least in part on the mTRP configuration.

Some aspects described herein relate to a method of wireless communication performed by a UE. The method may include receiving an mTRP configuration that indicates a first TCI state type corresponding to a first TRP and a second TCI state type corresponding to a second TRP. The method may include communicating based at least in part on the mTRP configuration.

Some aspects described herein relate to a method of wireless communication performed by a network node. The method may include transmitting an mTRP configuration that indicates a first TCI state type corresponding to a first TRP and a second TCI state type corresponding to a second TRP. The method may include communicating based at least in part on the mTRP configuration.

Some aspects described herein relate to an apparatus for wireless communication. The apparatus may include means for receiving an mTRP configuration that indicates a first TCI state type corresponding to a first TRP and a second TCI state type corresponding to a second TRP. The apparatus may include means for communicating based at least in part on the mTRP configuration.

Some aspects described herein relate to an apparatus for wireless communication. The apparatus may include means for transmitting an mTRP configuration that indicates a first TCI state type corresponding to a first TRP and a second TCI state type corresponding to a second TRP. The apparatus may include means for communicating based at least in part on the mTRP configuration.

Some aspects described herein relate to a non-transitory computer-readable medium that stores one or more instructions for wireless communication by a UE. The one or more instructions, when executed by one or more processors of the UE, may cause the UE to receive an mTRP configuration that indicates a first TCI state type corresponding to a first TRP and a second TCI state type corresponding to a second TRP. The one or more instructions, when executed by one or more processors of the UE, may cause the UE to communicate based at least in part on the mTRP configuration.

Some aspects described herein relate to a non-transitory computer-readable medium that stores one or more instructions for wireless communication by a network node. The one or more instructions, when executed by one or more processors of the network node, may cause the network node to transmit an mTRP configuration that indicates a first TCI state type corresponding to a first TRP and a second TCI state type corresponding to a second TRP. The one or more instructions, when executed by one or more processors of the network node, may cause the network node to communicate based at least in part on the mTRP configuration.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of single-downlink control information (DCI)-based multiple transmission reception point (mTRP) operation in accordance with the present disclosure.

FIGS. 5-9 are diagrams illustrating examples associated with configuring transmission configuration indicator (TCI) types for transmission reception points (TRPs) in mTRP operations, in accordance with the present disclosure.

FIGS. 10 and 11 are diagrams illustrating example processes associated with configuring TCI types for TRPs in mTRP operations, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

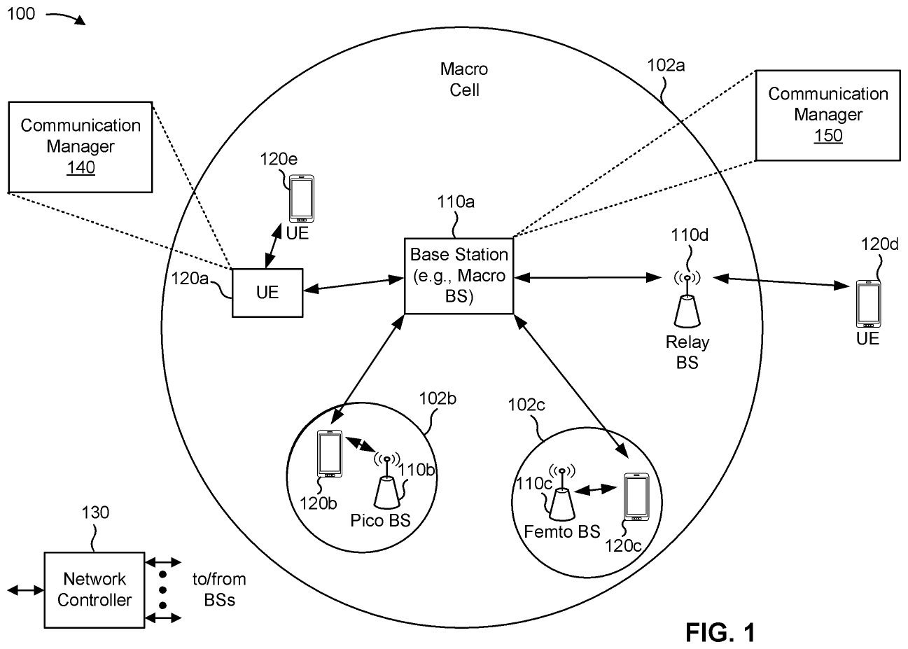

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A network node 110 is an entity that communicates with UEs 120. A network node 110 (sometimes referred to as an NN) may include, for example, an NR network node, an LTE network node, a Node B, an eNB (e.g., in 4G), a gNB (e.g., in 5G), an access point, and/or a transmission reception point (TRP). Each network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used.

A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the BS 110a may be a macro network node for a macro cell 102a, the BS 110b may be a pico network node for a pico cell 102b, and the BS 110c may be a femto network node for a femto cell 102c. A network node may support one or multiple (e.g., three) cells.

In some examples, a cell may not necessarily be stationary, and the geographic area of the cell may move according to the location of a network node 110 that is mobile (e.g., a mobile network node). In some examples, the network nodes 110 may be interconnected to one another and/or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network node 110 or a UE 120) and send a transmission of the data to a downstream station (e.g., a UE 120 or a network node 110). A relay station may be a UE 120 that can relay transmissions for other UEs 120. In the example shown in FIG. 1, the BS 110d (e.g., a relay network node) may communicate with the BS 110a (e.g., a macro network node) and the UE 120d in order to facilitate communication between the BS 110a and the UE 120d. A network node 110 that relays communications may be referred to as a relay station, a relay network node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which also may be referred to as a “node” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a UE (e.g., UE 120) may include a communication manager 140. As described in more detail elsewhere herein, the communication manager 140 may receive a multiple transmission-reception point (mTRP) configuration that indicates a first transmission configuration indicator (TCI) state type corresponding to a first transmission-reception point (TRP) and a second TCI state type corresponding to a second TRP; and communicate based at least in part on the mTRP configuration. Additionally, or alternatively, the communication manager 140 may perform one or more other operations described herein.

In some aspects, a network node may include a communication manager 150. As described in more detail elsewhere herein, the communication manager 150 may transmit an mTRP configuration that indicates a first TCI state type corresponding to a first TRP and a second TCI state type corresponding to a second TRP; and communicate based at least in part on the mTRP configuration. Additionally, or alternatively, the communication manager 150 may perform one or more other operations described herein.

As indicated above, FIG. 1 is provided as an example. Other examples may differ from what is described with regard to FIG. 1.

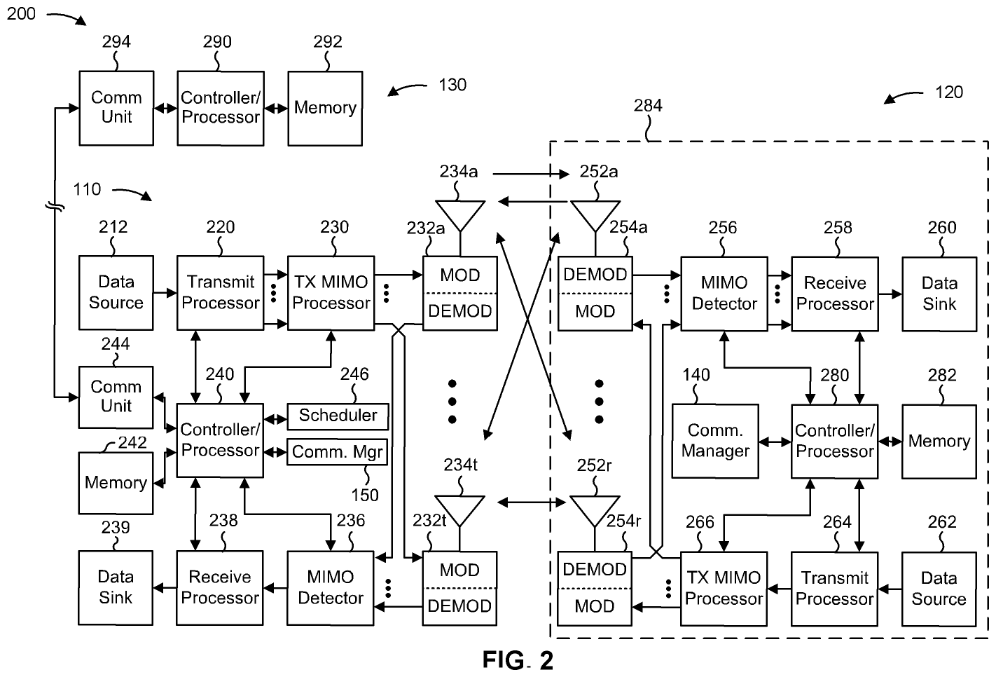

FIG. 2 is a diagram illustrating an example 200 of a network node 110 in communication with a UE 120 in a wireless network 100, in accordance with the present disclosure. The network node 110 may be equipped with a set of antennas 234a through 234t, such as T′ antennas (T≥1). The UE 120 may be equipped with a set of antennas 252a through 252r, such as R antennas (R≥1).

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of TCI states that respectively indicate beams that may be used by the UE, such as for receiving a physical downlink shared channel (PDSCH). The network node may indicate an activated TCI state to the UE, which the UE may use to select a beam for receiving the PDSCH.

A beam indication may be, or include, a TCI state information element, a beam ID, spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a channel state information (CSI)-reference signal (CSI-RS) (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_0, 1_1, 1_2, 0_1, 0_2, 0_0, and/or 2_x may be reused for beam indication. For example, DCI transmissions may include a beam indication having one of six types of beam indication for unified TCI. Type 1 may include a Joint DL/UL common TCI state (joint TCI) to indicate a common beam for at least one DL channel and/or reference signal plus at least one UL channel and/or reference signal. Type 2 may include a separate DL common TCI state to indicate a common beam for more than one DL channel and/or reference signal. Type 3 may include a separate UL common TCI state to indicate a common beam for more than one UL channel and/or reference signal. The separate DL and UL TCI state types may be referred to as “directional” TCI types, as each corresponds to a particular communication direction (either UL or DL). A source reference signal in unified TCIs may provide QCL information at least for at least one of PDSCH and physical downlink control channel (PDCCH) receptions in a serving cell, and a source reference signal in unified TCIs, if applicable, may provide a reference for determining common spatial transmit filter(s) for at least one of SRS, physical uplink shared channel (PUSCH) and physical uplink control channel (PUCCH) transmissions in a serving cell.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and directional DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

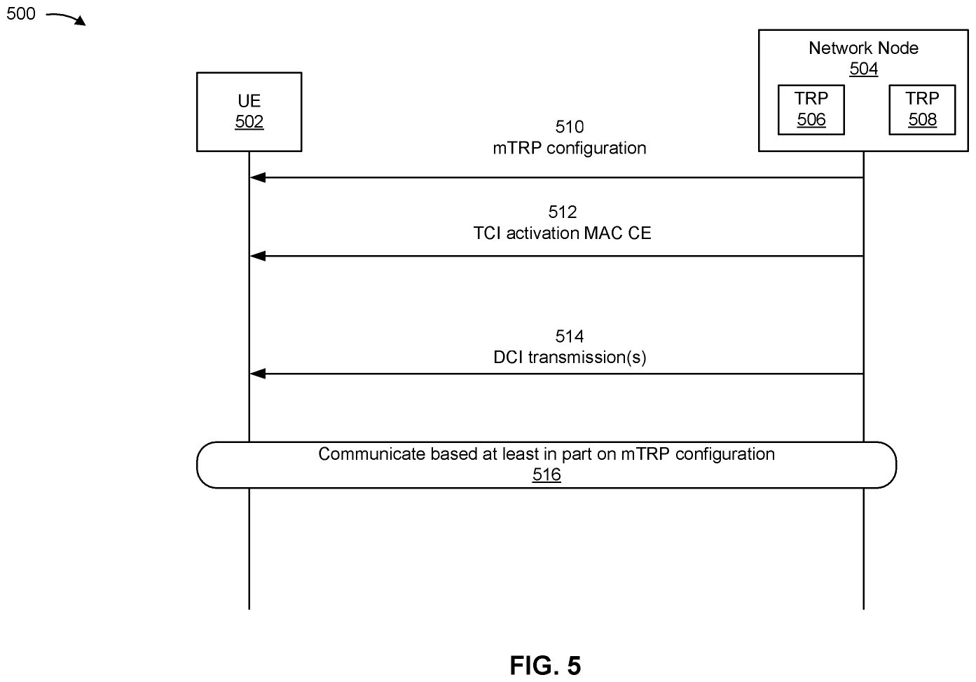

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

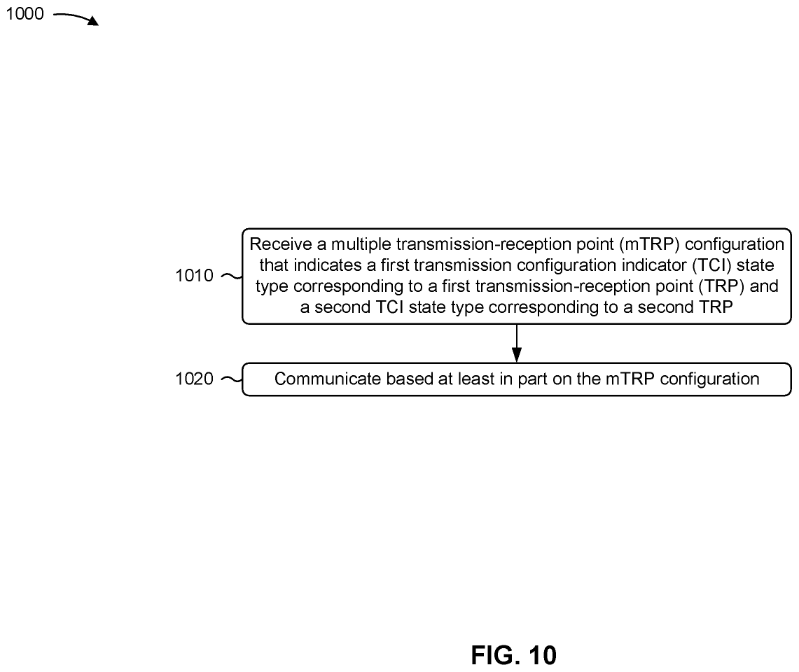

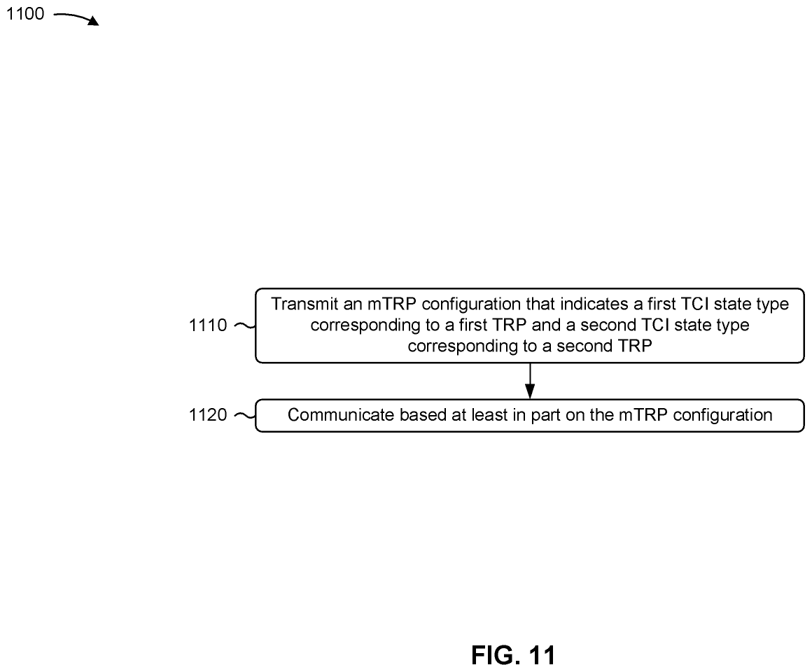

The controller/processor 240 of the network node 110, the controller/processor 280 of the UE 120, and/or any other component(s) of FIG. 2 may perform one or more techniques associated with configuring TCI types for TRPs in mTRP operations, as described in more detail elsewhere herein. In some aspects, the network node described herein is the network node 110, is included in the network node 110, or includes one or more components of the network node 110 shown in FIG. 2. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE includes means for receiving an mTRP configuration that indicates a first TCI state type corresponding to a first TRP and a second TCI state type corresponding to a second TRP; and/or means for communicating based at least in part on the mTRP configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an mTRP configuration that indicates a first TCI state type corresponding to a first TRP and a second TCI state type corresponding to a second TRP; and/or means for communicating based at least in part on the mTRP configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

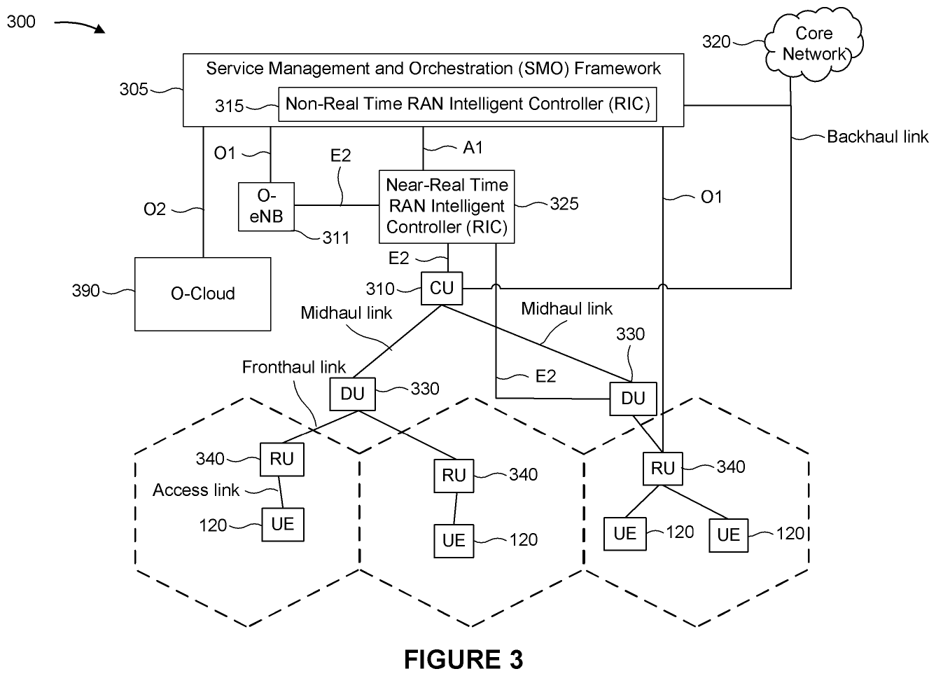

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

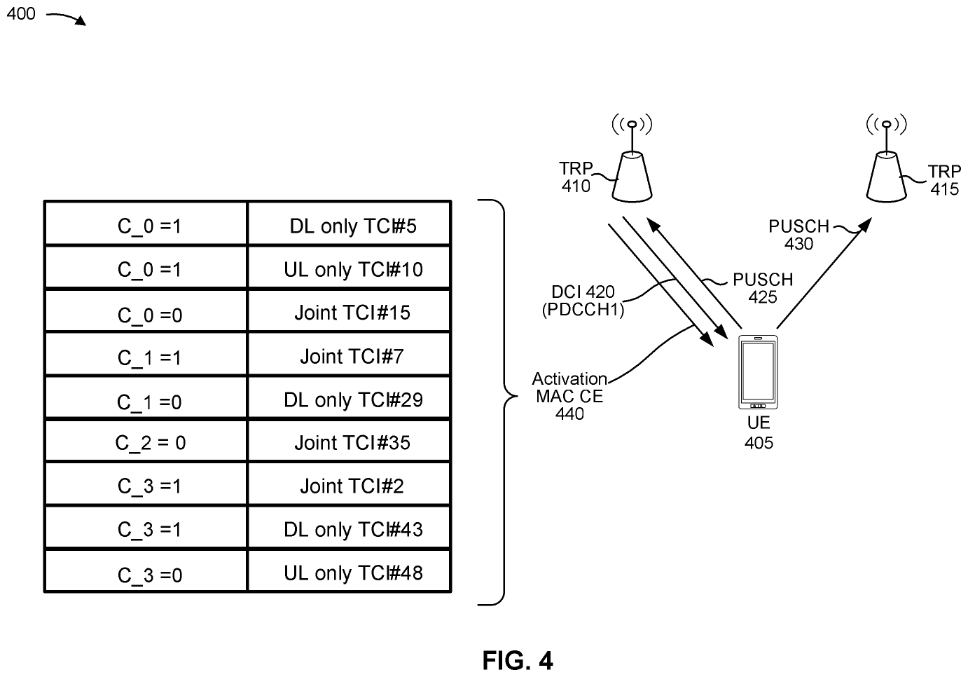

FIG. 4 is a diagram illustrating an example 400 of single-DCI-based mTRP operation in accordance with the present disclosure. As shown, a UE 405 may communicate with a first TRP 410 and a second TRP 415. The UE 405 may be configured with single-DCI-based mTRP operation. In some aspects, the TRP 410 and/or the TRP 415 may be, include, or be included in, a one or more network nodes (e.g., one or more base stations 110 described above in connection with FIGS. 1 and 2). For example, different TRPs 410 and 415 may be included in different network nodes. In some cases, multiple TRPs 410 and 415 may be included in a single network node. In some cases, a TRP 410 and/or a TRP 415 may be referred to as a cell, a panel, an antenna array, or an array. The UE 405 may be, include, or be included in the UE 120 described above in connection with FIGS. 1 and 2.

Multiple TRPs 410 and 415 can transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). A TCI state can be used to indicate one or more QCL relationships. A TRP 410 can be configured to individually (for example, using dynamic selection) or jointly (for example, using joint transmission with one or more other TRPs 410) serve traffic to the UE 405.

The UE 405 can be configured with single-DCI-based mTRP operation. As shown, when configured with single-DCI-based multi-TRP operation, the UE 405 can receive, from the TRP 410, a DCI transmission 420 in a first PDCCH transmission (shown as “PDCCH1”), where the DCI transmission 420 can schedule a first PUSCH transmission 425 for transmitting to the first TRP 410. The DCI transmission 420 also can schedule a second PUSCH transmission 430 for transmitting to the second TRP 415. In some cases, the DCI transmission 420 can schedule one or more PDSCH transmissions in addition to, or in lieu of, the PUSCH transmissions. In association with a monitoring DCI transmitted from the first TRP 410, the UE 405 can monitor PDCCH candidates in PDCCH monitoring occasions in a quantity of different control resource sets (CORESETs), as configured by the network.

In some cases, the first TRP 410 can be associated with a serving cell of the UE 405. For example, the first TRP 410 can be a base station that provides the serving cell, or a relay device that provides access to the serving cell. In some cases, a quantity of additional TRPs may be associated with a quantity of additional serving cells. In some cases, the second TRP 415 can be associated with a non-serving cell. To communicate with a cell and receive a DCI transmission, the UE 405 can acquire beam indications for beam selection based on a TCI state. In some cases, synchronization signal block (SSB) information can be used to perform channel measurement, obtain TCI state, or select beams for communication. The UE 405 can obtain SSB transmission position, SSB transmission periodicity, and SSB transmission power associated with the cell and use that information to facilitate receiving and decoding a DCI transmission.

For single-DCI mTRP, an activated TCI codepoint can be mapped to multiple unified TCI states having different types. For example, the TRP 410 can transmit, to the UE 405, an activation MAC CE 440. As shown, the activation MAC CE can indicate a TCI codepoint mapping. For example, as shown, TCI states can be mapped to codepoints (shown as “C_0,” “C_1,” “C_2,” and “C_3”), where C_x represents the last TCI state mapped to a codepoint. For each codepoint, the mapped TCI states can have the following combinations (note that the order listed in the MAC CE is ignored): {DL-only, UL-only, Joint}, {DL-only, Joint}, {UL-only, Joint}, {Joint, Joint}, {DL-only, DL-only, UL-only}, {DL-only, UL-only, UL-only}, and {DL-only, DL-only, UL-only, UL-only}. A codepoint can be mapped to up to two DL applicable TCIs and up to two UL applicable TCIs, where the DL applicable TCI may include DL TCI (DL-only) and joint TCI (Joint), and the UL applicable TCI may include UL TCI (UL-only) and joint TCI (joint). In some cases, a codepoint mapped to a single TCI can be a codepoint mapped to TCIs for a single TRP, which can be a codepoint mapped to a single DL TCI, a codepoint mapped to a single UL TCI, or a codepoint mapped to a single DL TCI and a single UL TCI. In some cases, a codepoint mapped to two TCIs can be a codepoint mapped to TCIs for two TRPs, where, for example, a codepoint can be mapped to a single DL TCI and a single joint TCI, or a codepoint can be mapped to two DL TCIs.

Unified TCI includes directional TCI and joint TCI. A UE can be configured with directional TCI or Joint TCI, or both. For example, a UE can be configured for one TRP with directional TCIs, and another TRP with joint TCIs. However, support for other combinations of TCI configurations may facilitate expanding options for mTRP communications, thereby adding flexibility to the network.

Some aspects of the techniques and apparatuses described herein provide for per-TRP TCI type configurations and indications. For example, a UE may receive an mTRP configuration that indicates a first TCI state type corresponding to a first TRP and a second TCI state type corresponding to a second TRP. The UE may communicate based at least in part on the mTRP configuration. In this way, some aspects may facilitate expanding options for mTRP TCI mapping and communication and, as a result, add flexibility to the network. Thus, some aspects may have a positive impact on network performance.

As indicated above, FIG. 4 is provided as an example. Other examples may differ from what is described with regard to FIG. 4.

FIG. 5 is a call-flow diagram illustrating an example 500 associated with configuring TCI types for TRPs in mTRP operations, in accordance with the present disclosure. As shown, a UE 502 and a network node 504 may communicate with one another. In some aspects, the UE 502 and the network node 504 may communicate with one another based on an mTRP configuration. In some aspects, the network node 504 may include a first TRP 506 and a second TRP 508, as shown. In some other aspects, one or both of the TRP 506 and the TRP 508 may be independent of the network node 504. The UE 502 may be, be similar to, include, or be included in, the UE 502 depicted in FIG. 5, the UE 405 depicted in FIG. 4, and/or the UE 120 depicted in FIGS. 1-3. The network node 504 may be, be similar to, include, or be included in, the TRP 410 and/or the TRP 415 depicted in FIG. 4, and/or the network node 110 depicted in FIGS. 1 and 2.

As shown by reference number 510, the network node 504 may transmit, and the UE 502 may receive an mTRP configuration. The mTRP configuration may include an RRC configuration and may indicate any number of configurations. In some aspects, for example, the mTRP configuration may indicate a first TRP ID corresponding to a the TRP 506 and a second TRP ID corresponding to the TRP 508. In some aspects, the mTRP configuration may indicate at least one of a channel or a reference signal associated with at least one TCI state of a plurality of TCI states. In some aspects, the mTRP configuration may configure a component carrier list indicating a plurality of frequency divisions. The plurality of frequency divisions may be associated with a unified TCI indication. In some aspects, the TRP 506 may be associated with a first CORESET pool index and the TRP 508 may be associated with a second CORESET pool index.

In some aspects, the mTRP configuration may indicate a first TCI state type corresponding to the TRP 506 and a second TCI state type corresponding to the TRP 508. In some aspects, for example, the first TCI state type may match the second TCI state type. A TCI state type matches another TCI state type when the two TCI state types are the same. In some aspects, the first TCI state type may be a joint TCI state type or a directional TCI state type. In some aspects, the first TCI state type may be a directional TCI state type, and the second TCI state type may be a joint TCI state type. For example, in some aspects, a wireless network may support a per-TRP TCI type (directional or joint TCI) configuration for a UE (e.g., the UE 502) in mTRP operation. In a first case, both TRPs may be configured with joint TCI types. In a second case, both TRPs may be configured with directional TCI types. In a third case, one TRP may be configured with a directional TCI type, and the other TRP may be configured with a joint TCI type.

As shown by reference number 512, the network node 504 may transmit, and the UE 502 may receive, a TCI activation MAC CE. The TCI activation MAC CE may include an activation indicator corresponding to at least one codepoint mapped to a plurality of TCI states. In some aspects, the at least one codepoint comprises a single codepoint. In some aspects, the mTRP configuration may include the TCI activation MAC CE. In some aspects, to support a codepoint mapped to a plurality of TCI states, the UE 502 may be configured with a CSI report to report one or more pairs of beams that can be simultaneously received or transmitted. For example, when the UE 502 is configured with a parameter “groupBasedBeamReporting-r17” in a group-based CSI report configuration “(′SI-ReportConfig”, the UE 502 may report the CSI resource indexes (CRIs) in pairs for the CSI report when the corresponding CSI resource set is not configured with a parameter of repetition set as “on,” and when the UE 502 is configured with “groupBasedBeamReporting-r17” in a group-based CSI report configuration “CSI-ReportConfig” in which a parameter of repetition is set as “on,” the UE 502 may not report CRI(s) for the CSI report.

As shown by reference number 514, the network node 504 may transmit, and the UE 502 may receive, one or more DCI transmissions. In some aspects, the mTRP configuration may correspond to a single downlink control information (sDCI) operation. In some aspects, for example, the mTRP configuration may include a TCI mapping that includes a TCI state activation field that maps a corresponding TCI state to a referenced TCI codepoint in the DCI transmission. In some aspects, the mapping between TCI states and TCI codepoints may be indicated by higher-layer signaling, such as TCI activation MAC-CE. For example, the TCI activation MAC-CE may activate multiple TCI codepoints, and the DCI may indicate a TCI codepoint selected from the multiple TCI codepoints to the UE 502.

The TCI state activation field may map a next TCI state, indicated in a next octet of the TCI mapping, based at least in part on a value of the TCI state activation field, wherein the value is a first value or a second value. For example, sDCI mTRP operation, the UE 502 may be activated for one or more TCIs for a TCI codepoint in DCI. A TCI activation field C_x may indicate that the corresponding TCI is activated for the xth TCI codepoint.

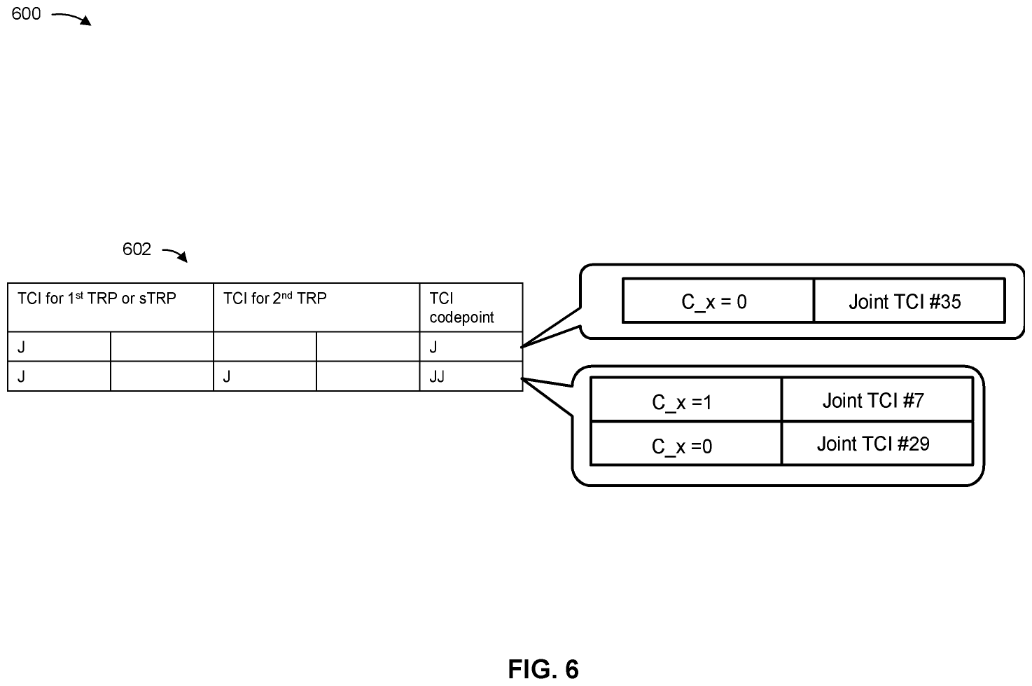

In some aspects, the next TCI state may be mapped to the referenced TCI codepoint based at least in part on the value being the first value (e.g., where C_x=1). In some aspects, the next TCI state may be mapped to a next TCI codepoint based at least in part on the value being the second value (e.g., wherein C_x=0). A set of TCI codepoints of the one or more TCI codepoints may be associated with one TRP of the first TRP and the second TRP, and each TCI state, of the one or more TCI states, that is associated a TCI codepoint of the set of TCI codepoints, may be associated with a directional TCI state type. In some aspects, a set of TCI codepoints of the one or more TCI codepoints may be associated with one TRP of the first TRP and the second TRP. Each TCI state, of the one or more TCI states, that is associated with a TCI codepoint of the set of TCI codepoints, may be associated with a joint TCI state type. In some aspects, for example, TCI states indicated in different TCI codepoints belonging to the same TRP may all be configured as directional TCI state types or joint TCI state types. FIGS. 6-9 depict a number of different implementation cases of TCI mappings for sDCI mTRP operations.

In some aspects, the mTRP configuration may correspond to a multiple downlink control information (mDCI) operation. The one or more DCI transmissions may include multiple DCI transmissions. A first DCI transmission may indicate a first set of TCI states, corresponding to the first TRP, associated with a first set of TCI codepoints, and a second set of TCI states, corresponding to the second TRP, associated with a second set of TCI codepoints. Each TCI state of the first set of TCI states may correspond to the first TCI state type, and each TCI state of the second set of TCI states may correspond to the second TCI state type. For example, for mDCI mTRP operation, for TCIs of different TCI codepoints activated per TRP, the TCI type may be configured per TRP.

In some aspects, the first TCI state type may be a directional TCI state type, and the second TCI state type may be a joint TCI state type. Each TCI codepoint of the first set of TCI codepoints may be associated with at least one of an uplink TCI state or a downlink TCI state, and each TCI codepoint of the second set of TCI codepoints may be associated with a joint TCI state. In some aspects, for example, for mDCI mTRP, one TRP may be configured to have directional TCI states and the other TRP may be configured to have joint TCI states. One TRP (e.g., the TRP 506) may be activated with TCI codepoints with a DL TCI state, a UL TCI state or a pair including a DL TCI state and a UL TCI state. The other TRP (e.g., TRP 508) may be activated with TCI codepoints with joint TCI states.

As shown by reference number 516, the UE 502 and the network node 504 may communicate based at least in part on the mTRP configuration.

As indicated above, FIG. 5 is provided as an example. Other examples may differ from what is described with regard to FIG. 5.

FIG. 6 is a diagram illustrating an example 600 associated with configuring TCI types for TRPs in mTRP operations, in accordance with the present disclosure. Example 600 may include, for example, a TCI state mapping 602, which may be indicated, for example, using a bitmap in a MAC CE. As shown, the state mapping 602 may indicate mappings of uplink TCI state types (shown as “U”), downlink TCI state types (shown as “D”), and joint TCI state types (shown as “J”) to codepoints. In example 600, a first TCI state type may be a joint TCI state type, and the second TCI state type may be the joint TCI state type. The one or more TCI codepoints may include a TCI codepoint indicating a first TCI state and a second TCI state, and the first TCI state may be associated with a first TRP and the second TCI state may be associated with a second TRP.

For example, as shown, the first TCI codepoint may include a TCI activation indication field that indicates, via a first value (C_x=0), a mapping of the first TCI codepoint to the joint TCI state #35. The second TCI codepoint may indicate two TCI states, one associated with the first TRP and the other associated with the second TRP. For example, as shown, the second TCI codepoint may include a first TCI activation indication field that indicates, via a second value (C_x=1), a mapping of the second TCI codepoint to the joint TCI state #7. The second TCI codepoint may include a second TCI activation indication field that indicates, via the first value (e.g. C_x=0), a mapping of the second TCI codepoint to the joint TCI state #29.

As indicated above, FIG. 6 is provided as an example. Other examples may differ from what is described with regard to FIG. 6. In the example, both TRPs are configured with TCI states having a joint TCI type, and the TCI states in all activated TCI codepoints are joint TCI states.

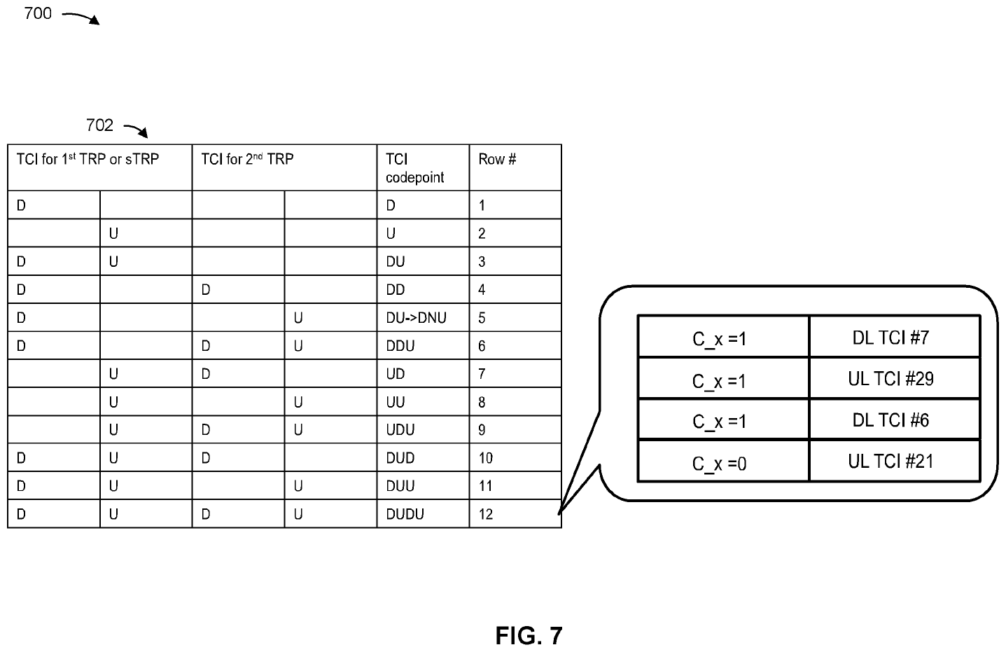

FIG. 7 is a diagram illustrating an example 700 associated with configuring TCI types for TRPs in mTRP operations, in accordance with the present disclosure. Example 700 may include, for example, a TCI state mapping 702, which may be indicated, for example, using a bitmap in a MAC CE. In example 700, both TCI state types (each of which is associated with a TRP) may be directional TCI state types.

For example, as shown, a TCI codepoint associated with row 12 may include a first TCI activation indication field that indicates, via a second value (C_x=1), a mapping of the TCI codepoint to the DL TCI state #7, a second TCI activation indication field that indicates, via the second value (C_x=1), a mapping of the TCI codepoint to the UL TCI state #29, a third TCI activation indication field that indicates, via the second value (C_x=1), a mapping of the TCI codepoint to the DL TCI state #6, and fourth TCI activation indication field that indicates, via the first value (C_x=0), a mapping of the TCI codepoint to the UL TCI state #21. In some cases, row 3 and row 5 of the TCI state mapping 702 may not be both supported due to ambiguity.

As indicated above, FIG. 7 is provided as an example. Other examples may differ from what is described with regard to FIG. 7. In the example, both TRPs are configured with TCI states having a directional TCI type, and the TCI states in all activated TCI codepoints are either DL TCI states or UL TCI states.

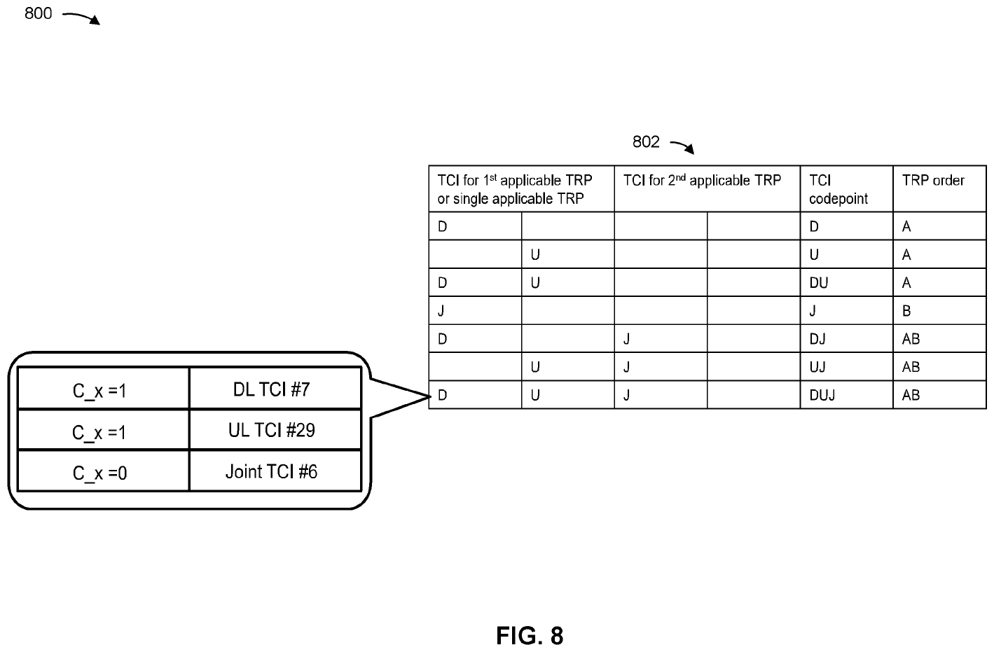

FIG. 8 is a diagram illustrating an example 800 associated with configuring TCI types for TRPs in mTRP operations, in accordance with the present disclosure. Example 800 may include, for example, a TCI state mapping 802, which may be indicated, for example, using a bitmap in a MAC CE. In example 800, a first TCI state type may be a directional TCI state type, and the second TCI state type may be a joint TCI state type. For example, the TRP A may be configured for directional TCI state only, and the TRP B may be configured for joint TCI state only. In example 800, a TCI state sweeping operation may be allowed in only one TCI codepoint of TCI codepoints activated.

As indicated above, FIG. 8 is provided as an example. Other examples may differ from what is described with regard to FIG. 8. In the example, the first TRP (e.g., TRP A) is configured with a TCI type of directional TCIs, and the second TRP (e.g., TRP B) is configured with TCI states having a joint TCI type. A TCI codepoint may be activated with two DL applicable TCI states (e.g., joint TCI or DL TCI), or two UL applicable TCI states (e.g., joint TCI or DL TCI), and for the TCI codepoints, the first DL or UL applicable TCI, which a separate DL or UL TCI, may be intended for the TRP A, and the second DL or UL applicable TCI, which is a joint TCI, may be intended for the TRP B.

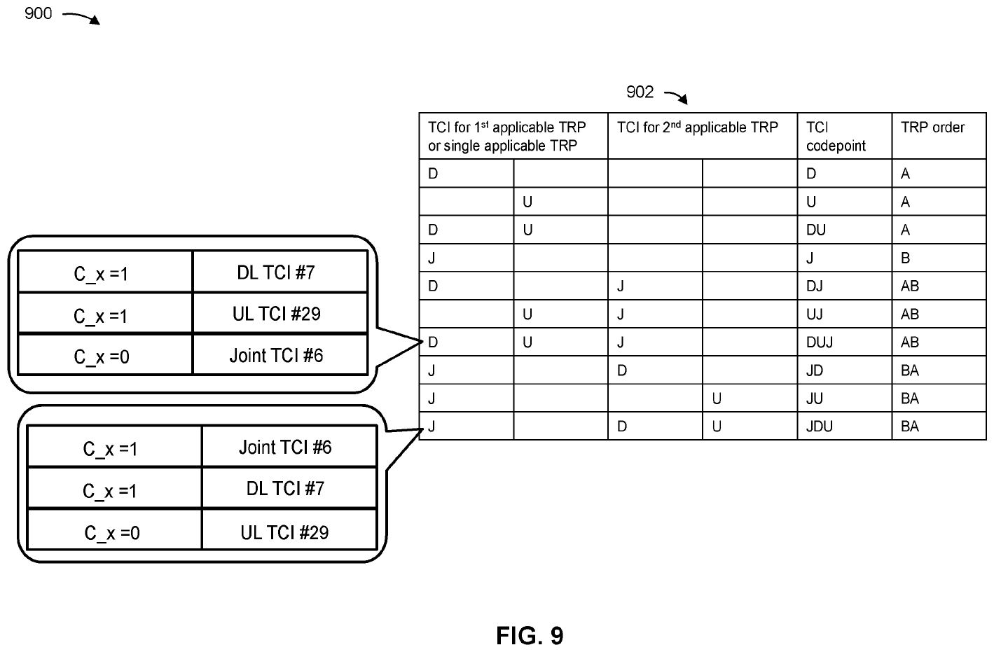

FIG. 9 is a diagram illustrating an example 900 associated with configuring TCI types for TRPs in mTRP operations, in accordance with the present disclosure. Example 900 may include, for example, a TCI state mapping 902, which may be indicated, for example, using a bitmap in a MAC CE. In example 900, a first TCI state type may be a directional TCI state type, and the second TCI state type may be a joint TCI state type. For example, the TRP A may be configured for directional TCI state only, and the TRP B may be configured for joint TCI state only. In example 900, a TCI state sweeping operation may be allowed in more than one TCI codepoint, as shown in association with the rows having D, U, and J TCI states.

As indicated above, FIG. 9 is provided as an example. Other examples may differ from what is described with regard to FIG. 9. In the example, the first TRP (e.g., TRP A) is configured with TCI states having a directional TCI type, and the second TRP (e.g., TRP B) is configured with TCI states having a joint TCI type. A TCI codepoint may be activated with two DL applicable TCI states (e.g., joint TCI or DL TCI), or two UL applicable TCIs (e.g., joint TCI or DL TCI), and the TRP order may be further indicated by TCI codepoints. In some TCI codepoints, the first DL or UL applicable TCI, which is a separate DL or UL TCI, may be intended for the TRP A and the second DL or UL applicable TCI, which is a joint TCI, may be intended for the TRP B. In some TCI codepoints, the first DL or UL applicable TCI, which is a joint TCI, may be intended for the TRP Band the second DL or UL applicable TCI, which is a separate DL or UL TCI, may be intended for the TRP A.

FIG. 10 is a diagram illustrating an example process 1000 performed, for example, by a UE, in accordance with the present disclosure. Example process 1000 is an example where the UE (e.g., UE 502) performs operations associated with configuring TCI types for TRPs in mTRP operations.

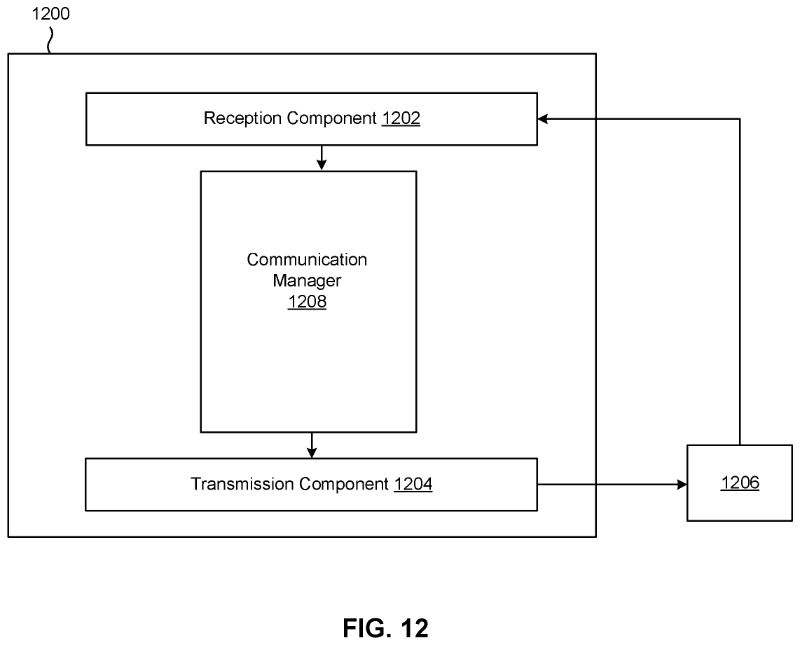

As shown in FIG. 10, in some aspects, process 1000 may include an mTRP configuration that indicates a first TCI state type corresponding to a TRP and a second TCI state type corresponding to a second TRP (block 1010). For example, the UE (e.g., using communication manager 1208 and/or reception component 1202, depicted in FIG. 12) may receive an mTRP configuration that indicates a TCI state type corresponding to a first TRP and a second TCI state type corresponding to a second TRP, as described above.

As further shown in FIG. 10, in some aspects, process 1000 may include communicating based at least in part on the mTRP configuration (block 1020). For example, the UE (e.g., using communication manager 1208, reception component 1202, and/or transmission component 1204, depicted in FIG. 12) may communicate based at least in part on the mTRP configuration, as described above.

Process 1000 may include additional aspects, such as any single aspect or any combination of aspects described below and/or in connection with one or more other processes described elsewhere herein.

In a first aspect, the first TCI state type matches the second TCI state type, and wherein the first TCI state type comprises a joint TCI state type. In a second aspect, alone or in combination with the first aspect, the first TCI state type matches the second TCI state type, and wherein the first TCI state type comprises a directional TCI state type. In a third aspect, alone or in combination with one or more of the first and second aspects, the first TCI state type comprises a directional TCI state type and the second TCI state type comprises a joint TCI state type.

In a fourth aspect, alone or in combination with one or more of the first through third aspects, the mTRP configuration corresponds to an sDCI operation, the method further comprising receiving a DCI transmission that indicates one or more TCI states associated with one or more TCI codepoints. In a fifth aspect, alone or in combination with the fourth aspect, the mTRP configuration comprises a TCI mapping that includes a TCI state activation field that maps a corresponding TCI state to a referenced TCI codepoint in the DCI transmission, wherein the TCI state activation field maps a next TCI state, indicated in a next octet of the TCI mapping, based at least in part on a value of the TCI state activation field, wherein the value is a first value or a second value.

In a sixth aspect, alone or in combination with the fifth aspect, the next TCI state is mapped to the referenced TCI codepoint based at least in part on the value being the first value. In a seventh aspect, alone or in combination with the sixth aspect, the next TCI state is mapped to a next TCI codepoint based at least in part on the value being the second value. In an eighth aspect, alone or in combination with one or more of the fourth through seventh aspects, a set of TCI codepoints of the one or more TCI codepoints is associated with one TRP of the first TRP and the second TRP, and wherein each TCI state, of the one or more TCI states, that is associated a TCI codepoint of the set of TCI codepoints, is associated with a directional TCI state type. In a ninth aspect, alone or in combination with one or more of the fourth through eighth aspects, a set of TCI codepoints of the one or more TCI codepoints is associated with one TRP of the first TRP and the second TRP, and wherein each TCI state, of the one or more TCI states, that is associated with a TCI codepoint of the set of TCI codepoints, is associated with a joint TCI state type.

In a tenth aspect, alone or in combination with the fourth aspect, first TCI state type is a joint TCI state type, and wherein the second TCI state type is the joint TCI state type. In an eleventh aspect, alone or in combination with one or more of the fourth through tenth aspects, the one or more TCI codepoints comprise a TCI codepoint indicating a first TCI state and a second TCI state, and wherein the first TCI state is associated with the first TRP and the second TCI state is associated with the second TRP. In a twelfth aspect, alone or in combination with the fourth aspect, the first TCI state type is a directional TCI state type, and wherein the second TCI state type is the directional TCI state type. In a thirteenth aspect, alone or in combination with the fourth aspect, the first TCI state type is a directional TCI state type, and wherein the second TCI state type is a joint TCI state type.

In a fourteenth aspect, alone or in combination with one or more of the fourth or thirteenth aspects, a TCI state sweeping operation is allowed in only one TCI codepoint of the one or more TCI codepoints. In a fifteenth aspect, alone or in combination with one or more of the first through fourteenth aspects, a TCI state sweeping operation is allowed in more than one TCI codepoint of the one or more TCI codepoints.

In a sixteenth aspect, alone or in combination with one or more of the first through fifteenth aspects, the m TRP configuration corresponds to an mDCI operation, the method further comprising receiving a plurality of DCI transmissions, wherein a first DCI transmission indicates a first set of TCI states, corresponding to the first TRP, associated with a first set of TCI codepoints, and a second set of TCI states, corresponding to the second TRP, associated with a second set of TCI codepoints.

In a seventeenth aspect, alone or in combination with the sixteenth aspect, each TCI state of the first set of TCI states corresponds to the first TCI state type, and wherein each TCI state of the second set of TCI states corresponds to the second TCI state type. In an eighteenth aspect, alone or in combination with the seventeenth aspect, the first TCI state type is a directional TCI state type, and wherein the second TCI state type is a joint TCI state type. In a nineteenth aspect, alone or in combination with the eighteenth aspect, each TCI codepoint of the first set of TCI codepoints is associated with at least one of an uplink TCI state or a downlink TCI state, and wherein each TCI codepoint of the second set of TCI codepoints is associated with a joint TCI state. In a twentieth aspect, alone or in combination with one or more of the first through nineteenth aspects, the first TRP is associated with a first CORESET pool index and the second TRP is associated with a second CORESET pool index.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 504) performs operations associated with configuring TCI types for TRPs in mTRP operations.

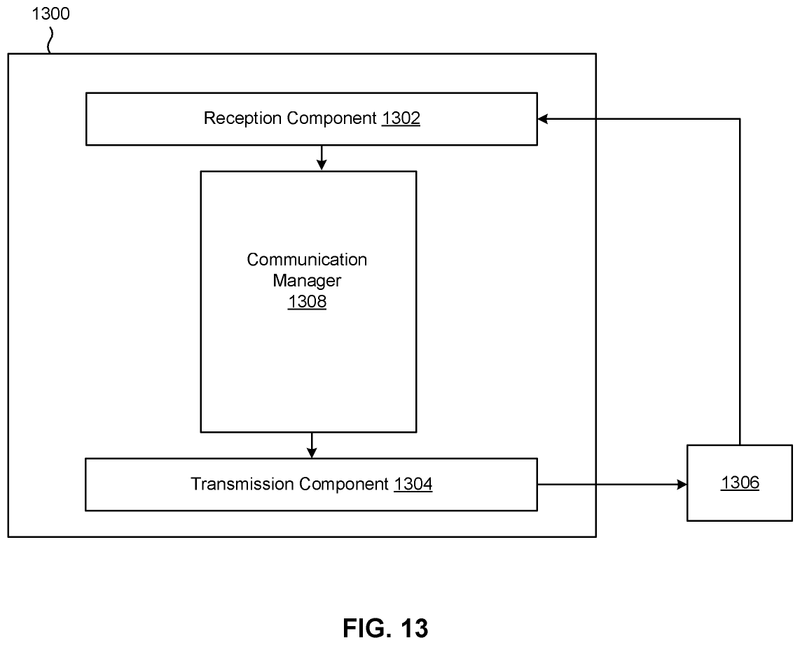

As shown in FIG. 11, in some aspects, process 1100 may include transmitting an mTRP configuration that indicates a first TCI state type corresponding to a first TRP and a second TCI state type corresponding to a second TRP (block 1110). For example, the network node (e.g., using communication manager 1308 and/or transmission component 1304, depicted in FIG. 13) may transmit an mTRP configuration that indicates a first TCI state type corresponding to a first TRP and a second TCI state type corresponding to a second TRP, as described above.

As further shown in FIG. 11, in some aspects, process 1100 may include communicating based at least in part on the mTRP configuration (block 1120). For example, the network node (e.g., using communication manager 1308, reception component 1302, and/or transmission component 1304, depicted in FIG. 13) may communicate based at least in part on the mTRP configuration, as described above.

Process 1100 may include additional aspects, such as any single aspect or any combination of aspects described below and/or in connection with one or more other processes described elsewhere herein.

In a first aspect, the first TCI state type matches the second TCI state type, and wherein the first TCI state type comprises a joint TCI state type. In a second aspect, alone or in combination with the first aspect, the first TCI state type matches the second TCI state type, and wherein the first TCI state type comprises a directional TCI state type. In a third aspect, alone or in combination with one or more of the first and second aspects, the first TCI state type comprises a directional TCI state type and the second TCI state type comprises a joint TCI state type. In a fourth aspect, alone or in combination with one or more of the first through third aspects, the mTRP configuration corresponds to an sDCI operation, the method further comprising transmitting a DCI transmission that indicates one or more TCI states associated with one or more TCI codepoints.

In a fifth aspect, alone or in combination with the fourth aspect, the mTRP configuration comprises a TCI mapping that includes a TCI state activation field that maps a corresponding TCI state to a referenced TCI codepoint in the DCI transmission, wherein the TCI state activation field maps a next TCI state, indicated in a next octet of the TCI mapping, based at least in part on a value of the TCI state activation field, wherein the value is a first value or a second value. In a sixth aspect, alone or in combination with the fifth aspect, the next TCI state is mapped to the referenced TCI codepoint based at least in part on the value being the first value. In a seventh aspect, alone or in combination with the fifth aspect, the next TCI state is mapped to a next TCI codepoint based at least in part on the value being the second value.

In an eighth aspect, alone or in combination with one or more of the fourth through seventh aspects, a set of TCI codepoints of the one or more TCI codepoints is associated with one TRP of the first TRP and the second TRP, and wherein each TCI state, of the one or more TCI states, that is associated a TCI codepoint of the set of TCI codepoints, is associated with a directional TCI state type. In a ninth aspect, alone or in combination with one or more of the fourth through eighth aspects, a set of TCI codepoints of the one or more TCI codepoints is associated with one TRP of the first TRP and the second TRP, and wherein each TCI state, of the one or more TCI states, that is associated with a TCI codepoint of the set of TCI codepoints, is associated with a joint TCI state type.

In a tenth aspect, alone or in combination with the fourth aspect, first TCI state type is a joint TCI state type, and wherein the second TCI state type is the joint TCI state type. In an eleventh aspect, alone or in combination with one or more of the fourth through tenth aspects, the one or more TCI codepoints comprise a TCI codepoint indicating a first TCI state and a second TCI state, and wherein the first TCI state is associated with the first TRP and the second TCI state is associated with the second TRP.

In a twelfth aspect, alone or in combination with the fourth aspect, the first TCI state type is a directional TCI state type, and wherein the second TCI state type is the directional TCI state type. In a thirteenth aspect, alone or in combination with the fourth aspect, the first TCI state type is a directional TCI state type, and wherein the second TCI state type is a joint TCI state type. In a fourteenth aspect, alone or in combination with one or more of the fourth or thirteenth aspects, a TCI state sweeping operation is allowed in only one TCI codepoint of the one or more TCI codepoints. In a fifteenth aspect, alone or in combination with one or more of the fourth or thirteenth aspects, a TCI state sweeping operation is allowed in more than one TCI codepoint of the one or more TCI codepoints.

In a sixteenth aspect, alone or in combination with one or more of the first through fifteenth aspects, the mTRP configuration corresponds to an mDCI operation, the method further comprising transmitting a plurality of DCI transmissions, wherein a first DCI transmission indicates a first set of TCI states, corresponding to the first TRP, associated with a first set of TCI codepoints, and a second set of TCI states, corresponding to the second TRP, associated with a second set of TCI codepoints. In a seventeenth aspect, alone or in combination with the sixteenth aspect, each TCI state of the first set of TCI states corresponds to the first TCI state type, and wherein each TCI state of the second set of TCI states corresponds to the second TCI state type. In an eighteenth aspect, alone or in combination with the seventeenth aspect, the first TCI state type is a directional TCI state type, and wherein the second TCI state type is a joint TCI state type. In a nineteenth aspect, alone or in combination with the eighteenth aspect, each TCI codepoint of the first set of TCI codepoints is associated with at least one of an uplink TCI state or a downlink TCI state, and wherein each TCI codepoint of the second set of TCI codepoints is associated with a joint TCI state. In a twentieth aspect, alone or in combination with one or more of the first through nineteenth aspects, the first TRP is associated with a first control resource set (CORESET) pool index and the second TRP is associated with a second CORESET pool index.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include a communication manager 1208.

In some aspects, the apparatus 1200 may be configured to perform one or more operations described herein in connection with FIGS. 4-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1208 and/or the reception component 1202 may receive an mTRP configuration that indicates a first TCI state type corresponding to a first TRP and a second TCI state type corresponding to a second TRP. In some aspects, the communication manager 1208 may include one or more antennas, a modem, a controller/processor, a memory, or a combination thereof, of the UE described in connection with FIG. 2. In some aspects, the communication manager 1208 may include the reception component 1202 and/or the transmission component 1204. In some aspects, the communication manager 1208 may be, be similar to, include, or be included in, the communication manager 140 depicted in FIGS. 1 and 2. The communication manager 1208, the reception component 1202, and/or the transmission component 1204 may communicate based at least in part on the mTRP configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a network node, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIGS. 4-9. Additionally, or alternatively, the apparatus 1300 may be configured to perform one or more processes described herein, such as process 1000 of FIG. 10, process 1100 of FIG. 11, or a combination thereof. In some aspects, the apparatus 1300 and/or one or more components shown in FIG. 13 may include one or more components of the UE or the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE or the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE or the network node described in connection with FIG. 2. In some aspects, the transmission component 1304 may be co-located with the reception component 1302 in a transceiver.

The transmission component 1304 may transmit an mTRP configuration that indicates a first TCI state type corresponding to a first TRP and a second TCI state type corresponding to a second TRP. In some aspects, the communication manager 1308 may include one or more antennas, a modem, a controller/processor, a memory, or a combination thereof, of the UE or the network node described in connection with FIG. 2. In some aspects, the communication manager 1308 may include the reception component 1302 and/or the transmission component 1304. In some aspects, the communication manager 1308 may be, be similar to, include, or be included in, the communication manager 150 depicted in FIGS. 1 and 2. The communication manager 1308, the reception component 1302, and/or the transmission component 1304, may communicate based at least in part on the mTRP configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving a multiple transmission-reception point (mTRP) configuration that indicates a first transmission configuration indicator (TCI) state type corresponding to a first transmission-reception point (TRP) and a second TCI state type corresponding to a second TRP; and communicating based at least in part on the mTRP configuration.
Aspect 2: The method of Aspect 1, wherein the first TCI state type matches the second TCI state type, and wherein the first TCI state type comprises a joint TCI state type.
Aspect 3: The method of Aspect 1, wherein the first TCI state type matches the second TCI state type, and wherein the first TCI state type comprises a directional TCI state type.
Aspect 4: The method of Aspect 1, wherein the first TCI state type comprises a directional TCI state type and the second TCI state type comprises a joint TCI state type.
Aspect 5: The method of any of Aspects 1-4, wherein the mTRP configuration corresponds to a single downlink control information (sDCI) operation, the method further comprising receiving a downlink control information (DCI) transmission that indicates one or more TCI states associated with one or more TCI codepoints.
Aspect 6: The method of Aspect 5, wherein the mTRP configuration comprises a TCI mapping that includes a TCI state activation field that maps a corresponding TCI state to a referenced TCI codepoint in the DCI transmission, wherein the TCI state activation field maps a next TCI state, indicated in a next octet of the TCI mapping, based at least in part on a value of the TCI state activation field, wherein the value is a first value or a second value.
Aspect 7: The method of Aspect 6, wherein the next TCI state is mapped to the referenced TCI codepoint based at least in part on the value being the first value.
Aspect 8: The method of Aspect 6, wherein the next TCI state is mapped to a next TCI codepoint based at least in part on the value being the second value.
Aspect 9: The method of any of Aspects 5-8, wherein a set of TCI codepoints of the one or more TCI codepoints is associated with one TRP of the first TRP and the second TRP, and wherein each TCI state, of the one or more TCI states, that is associated a TCI codepoint of the set of TCI codepoints, is associated with a directional TCI state type.
Aspect 10: The method of any of Aspects 5-8, wherein a set of TCI codepoints of the one or more TCI codepoints is associated with one TRP of the first TRP and the second TRP, and wherein each TCI state, of the one or more TCI states, that is associated with a TCI codepoint of the set of TCI codepoints, is associated with a joint TCI state type.
Aspect 11: The method of Aspect 5, wherein first TCI state type is a joint TCI state type, and wherein the second TCI state type is the joint TCI state type.
Aspect 12: The method of any of Aspects 5-11, wherein the one or more TCI codepoints comprise a TCI codepoint indicating a first TCI state and a second TCI state, and wherein the first TCI state is associated with the first TRP and the second TCI state is associated with the second TRP.
Aspect 13: The method of Aspect 5, wherein the first TCI state type is a directional TCI state type, and wherein the second TCI state type is the directional TCI state type.
Aspect 14: The method of Aspect 5, wherein the first TCI state type is a directional TCI state type, and wherein the second TCI state type is a joint TCI state type.
Aspect 15: The method of either of Aspects 5 or 14, wherein a TCI state sweeping operation is allowed in only one TCI codepoint of the one or more TCI codepoints.
Aspect 16: The method of either of Aspects 5 or 14, wherein a TCI state sweeping operation is allowed in more than one TCI codepoint of the one or more TCI codepoints.
Aspect 17: The method of any of Aspects 1-16, wherein the mTRP configuration corresponds to a multiple downlink control information (mDCI) operation, the method further comprising receiving a plurality of downlink control information (DCI) transmissions, wherein a first DCI transmission indicates a first set of TCI states, corresponding to the first TRP, associated with a first set of TCI codepoints, and a second set of TCI states, corresponding to the second TRP, associated with a second set of TCI codepoints.
Aspect 18: The method of Aspect 17, wherein each TCI state of the first set of TCI states corresponds to the first TCI state type, and wherein each TCI state of the second set of TCI states corresponds to the second TCI state type.
Aspect 19: The method of Aspect 18, wherein the first TCI state type is a directional TCI state type, and wherein the second TCI state type is a joint TCI state type.
Aspect 20: The method of Aspect 19, wherein each TCI codepoint of the first set of TCI codepoints is associated with at least one of an uplink TCI state or a downlink TCI state, and wherein each TCI codepoint of the second set of TCI codepoints is associated with a joint TCI state.
Aspect 21: The method of any of Aspects 1-20, wherein the first TRP is associated with a first control resource set (CORESET) pool index and the second TRP is associated with a second CORESET pool index.
Aspect 22: A method of wireless communication performed by a network node, comprising: transmitting a multiple transmission-reception point (mTRP) configuration that indicates a first transmission configuration indicator (TCI) state type corresponding to a first transmission-reception point (TRP) and a second TCI state type corresponding to a second TRP; and communicating based at least in part on the mTRP configuration.
Aspect 23: The method of Aspect 22, wherein the first TCI state type matches the second TCI state type, and wherein the first TCI state type comprises a joint TCI state type.
Aspect 24: The method of Aspect 22, wherein the first TCI state type matches the second TCI state type, and wherein the first TCI state type comprises a directional TCI state type.
Aspect 25: The method of Aspect 22, wherein the first TCI state type comprises a directional TCI state type and the second TCI state type comprises a joint TCI state type.
Aspect 26: The method of any of Aspects 22-25, wherein the mTRP configuration corresponds to a single downlink control information (sDCI) operation, the method further comprising transmitting a downlink control information (DCI) transmission that indicates one or more TCI states associated with one or more TCI codepoints.
Aspect 27: The method of Aspect 26, wherein the mTRP configuration comprises a TCI mapping that includes a TCI state activation field that maps a corresponding TCI state to a referenced TCI codepoint in the DCI transmission, wherein the TCI state activation field maps a next TCI state, indicated in a next octet of the TCI mapping, based at least in part on a value of the TCI state activation field, wherein the value is a first value or a second value.
Aspect 28: The method of Aspect 27, wherein the next TCI state is mapped to the referenced TCI codepoint based at least in part on the value being the first value.
Aspect 29: The method of Aspect 27, wherein the next TCI state is mapped to a next TCI codepoint based at least in part on the value being the second value.
Aspect 30: The method of any of Aspects 26-29, wherein a set of TCI codepoints of the one or more TCI codepoints is associated with one TRP of the first TRP and the second TRP, and wherein each TCI state, of the one or more TCI states, that is associated a TCI codepoint of the set of TCI codepoints, is associated with a directional TCI state type.
Aspect 31: The method of any of Aspects 26-29, wherein a set of TCI codepoints of the one or more TCI codepoints is associated with one TRP of the first TRP and the second TRP, and wherein each TCI state, of the one or more TCI states, that is associated with a TCI codepoint of the set of TCI codepoints, is associated with a joint TCI state type.
Aspect 32: The method of Aspect 26, wherein first TCI state type is a joint TCI state type, and wherein the second TCI state type is the joint TCI state type.
Aspect 33: The method of any of Aspects 26-32, wherein the one or more TCI codepoints comprise a TCI codepoint indicating a first TCI state and a second TCI state, and wherein the first TCI state is associated with the first TRP and the second TCI state is associated with the second TRP.
Aspect 34: The method of Aspect 26, wherein the first TCI state type is a directional TCI state type, and wherein the second TCI state type is the directional TCI state type.
Aspect 35: The method of Aspect 26, wherein the first TCI state type is a directional TCI state type, and wherein the second TCI state type is a joint TCI state type.
Aspect 36: The method of either of Aspects 26 or 35, wherein a TCI state sweeping operation is allowed in only one TCI codepoint of the one or more TCI codepoints.
Aspect 37: The method of either of Aspects 26 or 35, wherein a TCI state sweeping operation is allowed in more than one TCI codepoint of the one or more TCI codepoints.
Aspect 38: The method of any of Aspects 22-37, wherein the mTRP configuration corresponds to a multiple downlink control information (mDCI) operation, the method further comprising transmitting a plurality of downlink control information (DCI) transmissions, wherein a first DCI transmission indicates a first set of TCI states, corresponding to the first TRP, associated with a first set of TCI codepoints, and a second set of TCI states, corresponding to the second TRP, associated with a second set of TCI codepoints.
Aspect 39: The method of Aspect 38, wherein each TCI state of the first set of TCI states corresponds to the first TCI state type, and wherein each TCI state of the second set of TCI states corresponds to the second TCI state type.
Aspect 40: The method of Aspect 39, wherein the first TCI state type is a directional TCI state type, and wherein the second TCI state type is a joint TCI state type.
Aspect 41: The method of Aspect 40, wherein each TCI codepoint of the first set of TCI codepoints is associated with at least one of an uplink TCI state or a downlink TCI state, and wherein each TCI codepoint of the second set of TCI codepoints is associated with a joint TCI state.
Aspect 42: The method of any of Aspects 22-41, wherein the first TRP is associated with a first control resource set (CORESET) pool index and the second TRP is associated with a second CORESET pool index.
Aspect 43: An apparatus for wireless communication at a device, comprising a processor; memory coupled with the processor; and instructions stored in the memory and executable by the processor to cause the apparatus to perform the method of one or more of Aspects 1-21.
Aspect 44: A device for wireless communication, comprising memory, and one or more processors coupled to the memory, the memory comprising instructions executable by the one or more processors to cause the device to perform the method of one or more of Aspects 1-21.
Aspect 45: A device for wireless communication, comprising a memory and one or more processors coupled to the memory, the one or more processors configured to perform the method of one or more of Aspects 1-21.
Aspect 46: An apparatus for wireless communication, comprising at least one means for performing the method of one or more of Aspects 1-21.
Aspect 47: A non-transitory computer-readable medium storing code for wireless communication, the code comprising instructions executable by a processor to perform the method of one or more of Aspects 1-21.
Aspect 48: A non-transitory computer-readable medium storing a set of instructions for wireless communication, the set of instructions comprising one or more instructions that, when executed by one or more processors of a device, cause the device to perform the method of one or more of Aspects 1-21.
Aspect 49: An apparatus for wireless communication at a device, comprising a processor; memory coupled with the processor; and instructions stored in the memory and executable by the processor to cause the apparatus to perform the method of one or more of Aspects 22-42.
Aspect 50: A device for wireless communication, comprising memory, and one or more processors coupled to the memory, the memory comprising instructions executable by the one or more processors to cause the device to perform the method of one or more of Aspects 22-42.
Aspect 51: A device for wireless communication, comprising a memory and one or more processors coupled to the memory, the one or more processors configured to perform the method of one or more of Aspects 22-42.
Aspect 52: An apparatus for wireless communication, comprising at least one means for performing the method of one or more of Aspects 22-42.
Aspect 53: A non-transitory computer-readable medium storing code for wireless communication, the code comprising instructions executable by a processor to perform the method of one or more of Aspects 22-42.
Aspect 54: A non-transitory computer-readable medium storing a set of instructions for wireless communication, the set of instructions comprising one or more instructions that, when executed by one or more processors of a device, cause the device to perform the method of one or more of Aspects 22-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
memory; and
one or more processors coupled to the memory, the memory comprising instructions executable by the one or more processors to cause the UE to:
receive a multiple transmission-reception point (mTRP) configuration that indicates a first transmission configuration indicator (TCI) state type corresponding to a first transmission-reception point (TRP) and a second TCI state type corresponding to a second TRP; and
communicate based at least in part on the mTRP configuration.

2. The UE of claim 1, wherein the first TCI state type matches the second TCI state type, and wherein the first TCI state type comprises a joint TCI state type.

3. The UE of claim 1, wherein the first TCI state type matches the second TCI state type, and wherein the first TCI state type comprises a directional TCI state type.

4. The UE of claim 1, wherein the first TCI state type comprises a directional TCI state type and the second TCI state type comprises a joint TCI state type.

5. The UE of claim 1, wherein the mTRP configuration corresponds to a single downlink control information (sDCI) operation, and wherein the executable instructions are executable by the one or more processors to further cause the UE to receive a downlink control information (DCI) transmission that indicates one or more TCI states associated with one or more TCI codepoints.

6. The UE of claim 5, wherein the mTRP configuration comprises a TCI mapping that includes a TCI state activation field that maps a corresponding TCI state to a referenced TCI codepoint in the DCI transmission, wherein the TCI state activation field maps a next TCI state, indicated in a next octet of the TCI mapping, based at least in part on a value of the TCI state activation field, wherein the value is a first value or a second value.

7. The UE of claim 6, wherein the next TCI state is mapped to the referenced TCI codepoint based at least in part on the value being the first value.

8. The UE of claim 6, wherein the next TCI state is mapped to a next TCI codepoint based at least in part on the value being the second value.

9. The UE of claim 5, wherein a set of TCI codepoints of the one or more TCI codepoints is associated with one TRP of the first TRP and the second TRP, and wherein each TCI state, of the one or more TCI states, that is associated a TCI codepoint of the set of TCI codepoints, is associated with a directional TCI state type.

10. The UE of claim 5, wherein a set of TCI codepoints of the one or more TCI codepoints is associated with one TRP of the first TRP and the second TRP, and wherein each TCI state, of the one or more TCI states, that is associated with a TCI codepoint of the set of TCI codepoints, is associated with a joint TCI state type.

11. The UE of claim 5, wherein first TCI state type is a joint TCI state type, and wherein the second TCI state type is the joint TCI state type.

12. The UE of claim 5, wherein the one or more TCI codepoints comprise a TCI codepoint indicating a first TCI state and a second TCI state, and wherein the first TCI state is associated with the first TRP and the second TCI state is associated with the second TRP.

13. The UE of claim 5, wherein the first TCI state type is a directional TCI state type, and wherein the second TCI state type is the directional TCI state type.

14. The UE of claim 5, wherein the first TCI state type is a directional TCI state type, and wherein the second TCI state type is a joint TCI state type.

15. The UE of claim 5, wherein a TCI state sweeping operation is allowed in only one TCI codepoint of the one or more TCI codepoints.

16. The UE of claim 5, wherein a TCI state sweeping operation is allowed in more than one TCI codepoint of the one or more TCI codepoints.

17. The UE of claim 1, wherein the mTRP configuration corresponds to a multiple downlink control information (mDCI) operation, and wherein the executable instructions are executable by the one or more processors to further cause the UE to receive a plurality of downlink control information (DCI) transmissions, wherein a first DCI transmission indicates a first set of TCI states, corresponding to the first TRP, associated with a first set of TCI codepoints, and a second set of TCI states, corresponding to the second TRP, associated with a second set of TCI codepoints.

18. The UE of claim 17, wherein each TCI state of the first set of TCI states corresponds to the first TCI state type, and wherein each TCI state of the second set of TCI states corresponds to the second TCI state type.

19. The UE of claim 18, wherein the first TCI state type is a directional TCI state type, and wherein the second TCI state type is a joint TCI state type.

20. The UE of claim 19, wherein each TCI codepoint of the first set of TCI codepoints is associated with at least one of an uplink TCI state or a downlink TCI state, and wherein each TCI codepoint of the second set of TCI codepoints is associated with a joint TCI state.

21. The UE of claim 1, wherein the first TRP is associated with a first control resource set (CORESET) pool index and the second TRP is associated with a second CORESET pool index.

22. A network node for wireless communication, comprising:
memory; and
one or more processors coupled to the memory, the memory comprising instructions executable by the one or more processors to cause the network node to:
transmit a multiple transmission-reception point (mTRP) configuration that indicates a first transmission configuration indicator (TCI) state type corresponding to a first transmission-reception point (TRP) and a second TCI state type corresponding to a second TRP; and
communicate based at least in part on the mTRP configuration.

23. The network node of claim 22, wherein the first TCI state type matches the second TCI state type, and wherein the first TCI state type comprises a joint TCI state type or a directional TCI state type.

24. The network node of claim 22, wherein the first TCI state type comprises a directional TCI state type and the second TCI state type comprises a joint TCI state type.

25. The network node of claim 22, wherein the mTRP configuration corresponds to a single downlink control information (sDCI) operation, and wherein the executable instructions are executable by the one or more processors to further cause the network node to transmit a downlink control information (DCI) transmission that indicates one or more TCI states associated with one or more TCI codepoints.

26. The network node of claim 25, wherein the one or more TCI codepoints comprise a TCI codepoint indicating a first TCI state and a second TCI state, and wherein the first TCI state is associated with the first TRP and the second TCI state is associated with the second TRP.

27. A method of wireless communication performed by a user equipment (UE), comprising:
receiving a multiple transmission-reception point (mTRP) configuration that indicates a first transmission configuration indicator (TCI) state type corresponding to a first transmission-reception point (TRP) and a second TCI state type corresponding to a second TRP; and
communicating based at least in part on the mTRP configuration.

28. The method of claim 27, wherein the mTRP configuration corresponds to a downlink control information (sDCI) operation, the method further comprising receiving a downlink control information (DCI) transmission that indicates one or more TCI states associated with one or more TCI codepoints, wherein the one or more TCI codepoints comprise a TCI codepoint indicating a first TCI state and a second TCI state, and wherein the first TCI state is associated with the first TRP and the second TCI state is associated with the second TRP.

29. A method of wireless communication performed by a network node, comprising:
transmitting a multiple transmission-reception point (mTRP) configuration that indicates a first transmission configuration indicator (TCI) state type corresponding to a first transmission-reception point (TRP) and a second TCI state type corresponding to a second TRP; and
communicating based at least in part on the mTRP configuration.

30. The method of claim 29, wherein the mTRP configuration corresponds to a downlink control information (sDCI) operation, the method further comprising transmitting a downlink control information (DCI) transmission that indicates one or more TCI states associated with one or more TCI codepoints, wherein the one or more TCI codepoints comprise a TCI codepoint indicating a first TCI state and a second TCI state, and wherein the first TCI state is associated with the first TRP and the second TCI state is associated with the second TRP.
